(19) United States
(12) Patent Application Publication
(10) Pub. No.: US 2011/0298567 A1
(43) Pub. Date: Dec. 8, 2011

(54) SYSTEM AND METHOD FOR CONSTANT CHARACTERISTIC IMPEDANCE IN A FLEXIBLE TRACE INTERCONNECT ARRAY

(75) Inventors: Kevin Dale McKinstry, Arvada, CO (US); Otto Richard Buhler, Boulder, CO (US); Jeffrey Glenn Villiard, Broomfield, CO (US); Forest Dillinger, Golden, CO (US)

(73) Assignee: Oracle America, Inc., formerly known as Sun Microsystems, Inc., Redwood City, CA (US)

(21) Appl. No.: 13/213,369

(22) Filed: Aug. 19, 2011

Related U.S. Application Data
(62) Division of application No. 10/949,653, filed on Sep. 24, 2004, now abandoned.

(51) Int. Cl. H01P 3/08

(52) U.S. Cl. 333/238

(57) ABSTRACT

A system for matching impedance in a flexible trace interconnect array. The array comprising a flexible dielectric film, a plurality of trace conductors disposed along a longitudinal axis of the dielectric film, and a shield disposed along a section of the array, wherein at least one parameter of at least one of an unshielded section and of the shielded section is selected such that impedance of the unshielded section and impedance of the shielded section are substantially the same.

### CROSS-REFERENCE TO RELATED APPLICATION

This application is a divisional of application Ser. No. 10/949,653, filed Sep. 24, 2004, which is hereby incorporated by reference in its entirety.

### BACKGROUND OF THE INVENTION

1. Field of the Invention

This invention relates to a system and a method for constant characteristic impedance in a flexible trace interconnect array.

2. Background Art

Flexible trace interconnect arrays (or flex circuits) are generally implemented to connect electronic data transfer devices (e.g., tape read/write heads, disk drive read/write heads, etc.) to supporting circuitry (e.g., read device circuit boards, write device circuit boards, and the like). Flexible trace interconnect arrays are generally constructed of a flexible dielectric interposed between conductive traces (i.e., conductors).

Typically, a flexible trace interconnect array has both shielded and unshielded sections (i.e., regions, zones, etc.). The shield generally lowers the characteristic impedance of the trace sections proximate to the shield relative to a section of trace in the unshielded region. The impedance mis-match within a trace caused by shielded and unshielded sections typically generates undesirable signal reflections on the trace. Undesirable signal reflections may be particularly problematic during data write operations due to the higher signal bandwidth that is generally implemented to accommodate write signal rise-time considerations.

Thus, it would be desirable to have a method and a system for increasing or improving the impedance match (i.e., reducing impedance mis-match) between shielded and unshielded sections of a flexible trace interconnect array.

### SUMMARY

Accordingly, the present invention generally provides a system and method for increasing (or improving) the impedance match between shielded and unshielded sections of a flexible trace interconnect array. The reduction in impedance mis-match may provide a reduction in undesirable signal reflections on the conductive traces and a corresponding increase in successful data transfer operations (e.g., read/write operations). The system and method for improving conductor trace impedance match may be especially advantageously implemented in connection with write conductor traces.

According to the present invention, a flexible trace interconnect array is provided. The array comprises a flexible dielectric film, a plurality of trace conductors disposed along a longitudinal axis of the dielectric film, and a shield disposed along a section of the array. At least one parameter of at least one of an unshielded section and of the shielded section is selected such that impedance of the unshielded section and impedance of the shielded section are substantially the same.

Also according to the present invention, a method for matching impedance between a shielded section and an unshielded section of a flexible trace interconnect array is provided. The method comprises disposing a plurality of trace conductors along a longitudinal axis of a flexible dielectric film, disposing a shield along a section of the array, and selecting at least one parameter of at least one of the unshielded section and of the shielded section such that impedance of the unshielded section and impedance of the shielded section are substantially the same.

Still further according to the present method, a flexible trace interconnect array is provided. The array comprises a flexible dielectric film, and a plurality of trace conductors disposed along a longitudinal axis of the dielectric film. A first section of the array has a first trace conductor impedance, and a second section of the array has a second trace conductor impedance. At least one parameter of at least one of the first section and of the second section is selected such that impedance of the first section and impedance of the second section are substantially the same. The selected parameter is varied gradually along the longitudinal axis at an intersection of the first section and the second section such that wave reflection of signals presented by the array due to impedance mismatch is reduced.

These and other features and advantages of the present invention will be readily apparent upon consideration of the following detailed description of the invention in conjunction with the accompanying drawings.

### BRIEF DESCRIPTION OF THE DRAWINGS

FIG. 1 is a top view of a flexible trace interconnect array of the present invention; and

FIGS. 2(a-b) are cross-sectional end views of the flexible trace interconnect array of FIG. 1 at an unshielded region and at a shielded region, respectively.

### DETAILED DESCRIPTION

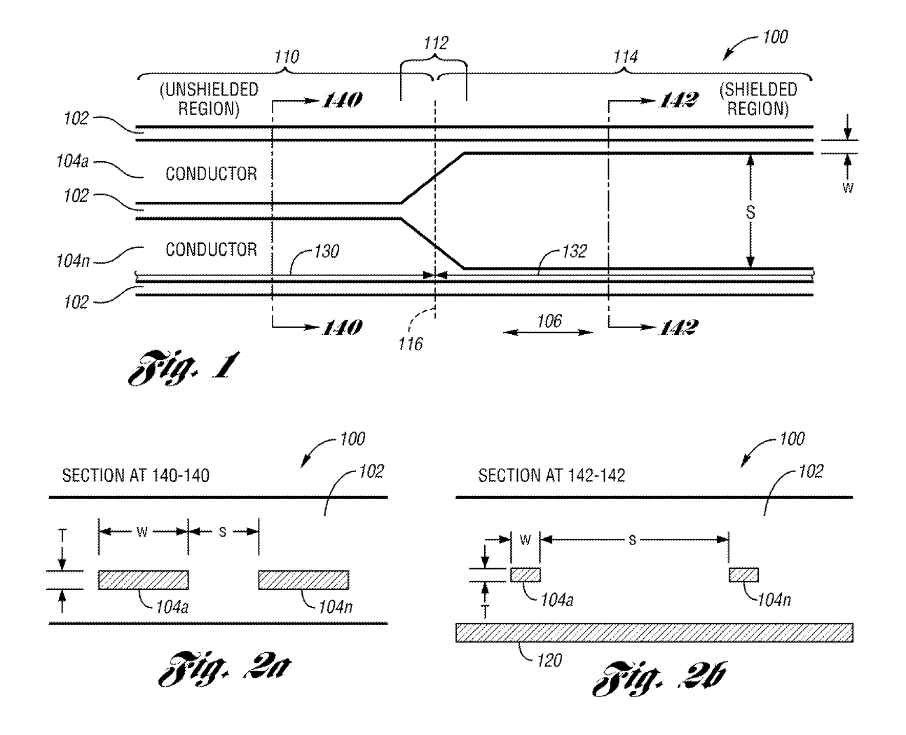

Referring to FIG. 1, a diagram illustrating a top view of a flexible trace interconnect array 100 of the present invention is shown. The trace interconnect array 100 generally comprises a dielectric material film (e.g., base, sheet, flexible substrate, etc.) 102 (e.g., polyimide, rubber, teflon, mylar, and the like) having a plurality of trace conductors 104 disposed (e.g., deposited, coated, sputtered, electroformed, plated, layered, laminated, silk-screened, etc.) thereon. Each trace conductor 104 generally comprises at least one electrically conductive material (e.g. gold, silver, copper, and the like) and is generally disposed as an array along a longitudinal axis 106.

A shield 120 (shown in detail in FIG. 2b), may be implemented (e.g., deposited on the film 102) within a region (e.g., region 114) of the trace array 100. The shield 120 is generally implemented to provide electrical and magnetic shielding for signals that are transmitted and received using the array 100. The shield 120 generally lowers characteristic impedance, Z0, of a section of trace 104 within the shielded region 114 when compared to a trace section 104 within the unshielded region 110.

Undesirable signal reflections may occur in a conductor (e.g., trace conductors 104) when the conductor includes regions of differing characteristic impedances Z0. As such, undesirable signal reflections (not shown) may be introduced into signals that are transmitted an received (i.e., carried on, presented by, etc.) the traces 104 at an intersection 116 of the unshielded section 114 and the shielded section 110.

The characteristic impedance Z0 of each trace 104 in the trace array 100 may be substantially determined by physical and electrical properties (i.e., characteristics, parameters, variables, etc.) of the dielectric material 102 and geometry of the trace 104. For a lossless line, the characteristic impedance may be approximated by the equation Z0=(L/C)^{1/2}, where L is inductance per unit length and C is capacitance per unit length.

For clarity of description, a section of a trace 104 within the unshielded region 110 of the array 100 will be denoted as an unshielded trace section 130 in the description that follows. Similarly, a section of a trace 104 within the shielded region 114 of the array 100 will be denoted a shielded trace section 132.

As a width, W, of a conductor (e.g., trace conductor 104) increases, the inductance L of the conductor (e.g., a trace 104) may decrease. The decrease in the inductance L of the conductor may result in a corresponding decrease in the characteristic impedance Z0 of the conductor. As such, the characteristic impedance Z0 of the unshielded trace section 130 may be reduced by increasing the width W of the unshielded trace section 130. Alternatively (or concurrently), the characteristic impedance Z0 of the shielded trace section 132 may be increased by decreasing the width W of the shielded trace section 132.

Similarly, a reduction in the characteristic impedance Z0 of conductors may be generated from a reduction in a gap (i.e., spacing, offset, etc.), S, between adjacent conductors (e.g., trace conductors 104a and 104n). The reduction in the spacing S between the conductors may provide a corresponding reduction in the inductance L and an increase in the capacitance C of the adjacent conductors. Accordingly, the characteristic impedance Z0 of the unshielded trace section 130 may be reduced by decreasing the spacing S (i.e., gap) between adjacent traces 104 (e.g., traces 104a and 104n) within the unshielded region 110. Alternatively (or concurrently), the characteristic impedance Z0 of the shielded trace section 132 may be increased by increasing the spacing S between adjacent traces 104 within the shielded region 114.

The characteristic impedance Z0 may also be reduced by increasing at least one of a dielectric constant and a dielectric thickness (i.e., dielectric density) of the dielectric material used in the base 102 between the conductors (e.g., between trace conductors 104a and 104n). Increasing the dielectric constant and thickness generally increases the capacitance C of the conductors and may provide in a corresponding reduction in the characteristic impedance Z0 of the conductors.

As such, the characteristic impedance Z0 of the unshielded trace section 130 may be reduced by implementing a dielectric material 102 within the unshielded region 110 having at least one of a greater dielectric constant and greater dielectric thickness when compared to the dielectric of the film 102 in the shielded region 114. Alternatively (or concurrently), the characteristic impedance Z0 of the shielded trace section 132 may be increased by implementing a dielectric material 102 within the shielded region 114 having at least one of a lower dielectric constant and lower dielectric thickness when compared to the dielectric of the film 102 in the unshielded region 110.

The present invention provides for selecting (i.e., choosing, sizing, determining, etc.) at least one parameter (e.g., trace conductor 104 width, trace conductor 104 thickness, spacing between trace conductors 104, dielectric material used to make the film 102, density of the dielectric material used to make the film 102, and the like) such that the characteristic impedance of the unshielded section 110 and the shielded section 114 of the flexible interconnect array 100 may be substantially the same. In one example, the at least one parameter may be selected in connection with the section 110. In another example, the at least one parameter may be selected in connection with the section 114. In yet another example, the parameter may be selected in connection with both the section 110 and the section 114.

Referring to FIGS. 2a and 2b, diagrams illustrating end cross-sectional views of the flexible trace interconnect array 100 of FIG. 1 taken at lines 140-140 and 142-142, respectively, are shown. As a thickness, T, of a conductor increases, the inductance L may decrease and the capacitance C may increase. The reduction (i.e., decrease, lowering, etc.) in the inductance L and the increase in the capacitance C of the conductor may result in a corresponding decrease in the characteristic impedance Z0 of the conductor.

Viewing FIGS. 2a and FIG. 2b together, the characteristic impedance Z0 of the unshielded trace section 130 (cross-section shown in detail in FIG. 2a) may be reduced to substantially match the impedance Z0 of the shielded trace section 132 (cross-section shown in detail in FIG. 2b) by increasing the thickness T of the unshielded trace section 130. Alternatively (or concurrently), the characteristic impedance Z0 of the shielded trace section 132 may be increased to substantially match the impedance Z0 of the unshielded trace section 130 by decreasing the thickness T of the shielded trace section 132.

A transition region 112 (shown in detail in FIG. 1) may be implemented between the shielded region 114 and the unshielded region 110. The transition region 112 may reduce undesirable signal reflections generated at a step change in a parameter (i.e., factor, attribute, characteristic, etc.) (e.g., non-shielded to shielded conductors width W, spacing S, thickness T, dielectric constant, dielectric thickness, etc.) of the trace array 100. The reduction in the undesirable signal reflections may be provided by gradual modification (i.e., reducing or eliminating the step change) of at lease one trace parameter within the transition region 112.

In one example, the width W of a trace conductor 104 may be increased gradually within the transition region 112. In another example, the spacing S between adjacent conductors (e.g., traces 104a and 104n) may be reduced gradually within the transition region 112. In yet another example, the thickness T of a trace conductor 104 may be increased gradually within the transition region 112. In still another example, at least one of the dielectric properties (i.e., a property of the dielectric 102) of thickness and dielectric constant are generally increased gradually within the transition region 112. However, any parameter of the trace array 100 may be modified in any appropriate manner within the transition region 112 to reduce undesirable signal reflections on the trace conductors 104.

Thus, the system and the method for constant characteristic impedance of the present invention generally provide increased matching of impedance between sections of flexible trace interconnect array (e.g., matching of impedance between shielded and non-shielded sections) when compared to conventional approaches to the construction of flexible interconnect arrays. As such, undesirable signal reflections due to impedance mis-match are generally reduced or eliminated using the novel and unique system and method of the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A flexible trace interconnect array, the array comprising:
a flexible dielectric film;
a plurality of trace conductors disposed along a longitudinal axis of the dielectric film; and
a shield disposed along a section of the array, wherein at least one parameter of at least one of an unshielded section and of the shielded section is selected such that impedance of the unshielded section and impedance of the shielded section are substantially the same.

2. The array of claim 1 wherein the selected parameter is trace conductor width, and at least one of the trace conductors has a width that is greater along the unshielded section than a width along the shielded section.

3. The array of claim 1 wherein the selected parameter is trace conductor thickness, and at least one of the trace conductors has a thickness that is greater along the unshielded section than a thickness along the shielded section.

4. The array of claim 1 wherein the selected parameter is spacing between the trace conductors, and the spacing between at least two of the trace conductors in the unshielded section is less than the spacing between the at least two trace conductors in the shielded section.

5. The array of claim 1 wherein the selected parameter is dielectric constant of the film, and the dielectric constant of the film in the unshielded section is greater than the dielectric constant of the film in the shielded section.

6. The array of claim 1 wherein the selected parameter is dielectric density of the film, and the dielectric density of the film in the unshielded section is greater than the dielectric density of the film in the shielded section.

7. The array of claim 1 wherein the selected parameter varies gradually along the longitudinal axis at an intersection of the shielded section and the unshielded section such that wave reflection of signals presented by the array due to impedance mismatch is reduced.

8. The array of claim 7 wherein the selected parameter varies at least one of linearly, and exponentially.

9. A method for matching impedance between a shielded section and an unshielded section of a flexible trace interconnect array, the method comprising:
disposing a plurality of trace conductors along a longitudinal axis of a flexible dielectric film, and a shield along a section of the array; and
selecting at least one parameter of at least one of the unshielded section and of the shielded section such that impedance of the unshielded section and impedance of the shielded section are substantially the same.

10. The method of claim 9 wherein the selected parameter is trace conductor width, and at least one of the trace conductors has a width that is greater along the unshielded section than a width along the shielded section.

11. The method of claim 9 wherein the selected parameter is trace conductor thickness, and at least one of the trace conductors has a thickness that is greater along the unshielded section than a thickness along the shielded section.

12. The method of claim 9 wherein the selected parameter is spacing between the trace conductors, and the spacing between at least two of the trace conductors in the unshielded section is less than the spacing between the at least two trace conductors in the shielded section.

13. The method of claim 9 wherein the selected parameter is dielectric constant of the film, and the dielectric constant of the film in the unshielded section is greater than the dielectric constant of the film in the shielded section.

14. The method of claim 9 wherein the selected parameter is dielectric density of the film, and the dielectric density of the film in the unshielded section is greater than the dielectric density of the film in the shielded section.

15. The method of claim 9 wherein the selected parameter is varied gradually along the longitudinal axis at an intersection of the shielded section and the unshielded section such that wave reflection of signals presented by the array due to impedance mismatch is reduced.

16. The method of claim 15 wherein the selected parameter is varied at least one of linearly, and exponentially.

17. A flexible trace interconnect array, the array comprising:
a flexible dielectric film; and
a plurality of trace conductors disposed along a longitudinal axis of the dielectric film, wherein a first section of the array has a first trace conductor impedance, a second section of the array has a second trace conductor impedance, at least one parameter of at least one of the first section and of the second section is selected such that impedance of the first section and impedance of the second section are substantially the same, and the selected parameter is varied gradually along the longitudinal axis at an intersection of the first section and the second section such that wave reflection of signals presented by the array due to impedance mismatch is reduced.

18. The array of claim 17 wherein the selected parameter is trace conductor width, and at least one of the trace conductors has a width that is greater along the first section than a width along the second section.

19. The array of claim 17 wherein the selected parameter is spacing between the trace conductors, and the spacing between at least two of the trace conductors in the first section is less than the spacing between the at least two trace conductors in the second section.

20. The array of claim 17 wherein the selected parameter is dielectric constant of the film, and the dielectric constant of the film in the first section is greater than the dielectric constant of the film in the second section.
